(19) United States
(12) Patent Application Publication
(10) Pub. No.: US 2024/0410645 A1
(43) Pub. Date: Dec. 12, 2024

(54) A POWER SWITCH ARRANGEMENT FOR COOLING DEVICE

(71) Applicant: BSH Hausgeräte GmbH, München (DE)

(72) Inventors: Ashish Modi, Istanbul (TR); Yigit Akalan, Knoxville, TN (US); Samuel Harward, Knoxville, TN (US); Erdi Emek, Tekirdag (TR)

(21) Appl. No.: 18/698,579

(22) PCT Filed: Sep. 21, 2022
(86) PCT No.: PCT/EP2022/076189

§ 371 Date: Apr. 4, 2024

(30) Foreign Application Priority Data
Oct. 6, 2021 (TR) 2021/015548
Jul. 26, 2022 (TR) 2022/011869

(51) Int. Cl. F25D 29/00; H01H 3/16

(52) U.S. Cl. CPC F25D 29/005; H01H 3/161

(57) ABSTRACT

A cooling device includes a body and a power switch arrangement having a switch housing fixed on an outer side surface facing outside, of the body and a power switch positioned in the switch housing. The switch housing of the power switch arrangement is configured to be mounted to a switch holder part, and the switch holder part of the power switch arrangement includes a first engagement portion disposed to be slidably engaged with a second engagement portion provided on the outer side surface. A power switch assembly method for a cooling device is also provided.

### TECHNICAL FIELD

The present invention relates to a cooling device comprising a body, and a power switch arrangement, particularly a main power switch arrangement according to the preamble of claim 1.

### KNOWN STATE OF THE ART

Cooling devices comprise switches for controlling the power. Main power switches generally located on lower areas or back areas of the cooling devices where it is hard to reach. Complexity of the assembly creates high costs and long assembly times.

A prior art reference relevant to the technical field of the present invention is the CN105605880B publication. CN105605880B relates to a power switch assembly for a refrigerator. A power switch assembly for a refrigerator includes a refrigerator end cover, a matching groove is arranged on the refrigerator end cover, the power switch assembly is arranged on the matching groove, and includes a rocker switch, a circuit board, a switch bracket and a surface board texture. Through the improvement of the above-mentioned structure, the present invention utilizes the integrated design of the rocker switch, wire terminal, and power signal indicator on the circuit board, and then stores the power indicator signal light on the switch bracket, and cleverly integrates the rocker switch, wire terminal, and power source. The signal indicator lamp and the circuit board are combined together, thereby achieving the purpose of intuitively understanding the power status of the refrigerator through the power indicator lamp, effectively overcoming the inconvenience of the prior art refrigerator switch machine, and having strong practicability.

### BRIEF DESCRIPTION OF THE INVENTION

The object of the present invention is to provide a power switch arrangement for cooling devices where assembly of the power switch is facilitated.

The present invention proposes a cooling device comprising a body, and a power switch arrangement having a switch housing fixed on an outer side surface facing outside, of the body and a power switch positioned in the switch housing. Accordingly, In the present invention the switch housing of the power switch arrangement is configured to be mounted to a switch holder part, and the switch holder part of the power switch arrangement comprises a first engagement portion arranged to slidably be engaged with a second engagement portion provided on an external fixing part connected to the outer side surface. Thus, the switch holder part is slid inside the second engagement portion easily and smoothly, since the second engagement portion has a smooth surface.

In a possible embodiment of the present invention, the fixing part comprises a base portion and a mounting portion provided on the base portion, and wherein the second engagement portion is provided in between the base portion and the mounting portion. Therefore, the second engagement portion is provided at the fixing part in such a way that the most extreme surface variation of the outer side surface does not encroach into the second engagement portion. In other words, the first engagement portion is slid into the second engagement portion without affecting from the roughness of the outer side surface. Thus, sliding movement of the first engagement portion is made easier and smoother.

In a possible embodiment of the present invention, the fixing part has at least one first connection protrusion, the switch holder part has at least one respective first connection housing, and the first connection protrusion and the first connection housing are sized and shaped to engage each other. Thus, the switch holder part is connected to the fixing part without using any mechanical fastening element. Besides, the switch holder part is removably connected to the fixing part.

In a possible embodiment of the present invention, a cover part is provided on the outer side surface so as to be configured in a perpendicular plane with respect to the outer side surface, wherein the cover part is provided with at least one second connection protrusion extending outside of the body, wherein the switch holder part comprises a respective second connection housing, and wherein the second connection protrusion and the second connection housing are sized and shaped to engage each other. Thus, the switch holder part is connected to the cover part in a removable manner. Besides, connecting the switch holder part to the cover part is made easier since no mechanical fastening element is used for connection.

In a possible embodiment of the present invention, the fixing part is configured to be removably assembled to the body by means of at least three mounting members which are provided in such a way as to form an imaginary triangle when the centers of the mounting members are joined by imaginary lines. Thus, the fixing part is assembled to the body firmly. In a preferred embodiment of the present invention, the mounting member is a screw. Therefore, the fixing part is easily removed from the outer side surface when desired by unscrewing the mounting members via a tool.

In a possible embodiment of the present invention, a second engagement portion provided on the outer side surface. Thus, the power switch can easily be fixed to the body of the cooling device.

In a possible embodiment of the present invention, an external fixing part comprising the second engagement portion, is configured to be removably connected to the body. Thus, position of the fixing part is easily changeable.

In a possible embodiment of the present invention, the first engagement portion has at least one engagement extension and said engagement extension is at least partially placed into at least one engagement channel of the second engagement portion. Thus, movement of the switch holder part with respect to the fixing part is delimited.

In a possible embodiment of the present invention, two engagement extensions and two engagement channels are provided. Thus, the switch holder part tightly holds the fixing part.

In a possible embodiment of the present invention, the switch holder part has a sleeve remaining between the engagement extensions, and wherein the fixing part is at least partially being inside the sleeve, when the engagement extensions at least partially placed into the engagement channels. Thus, the switch holder part tightly holds the fixing part.

In a possible embodiment of the present invention, the switch holder part comprises a front wall extending in a direction away from the outer side surface so as to define a connection region for mounting the switch housing. Thus, the switch housing can be mounted to the switch holder.

In a possible embodiment of the present invention, the front wall comprises at least one receiving opening through which the switch housing passes in a tight-fit manner, when the switch housing mounted to the switch holder part. Thus, the switch holder part easily holds the switch housing.

In a possible embodiment of the present invention, the switch housing comprises at least one fixing arm rested to a first wall surface of the front wall and wherein the switch housing comprises at least one stopper wall rested to a second wall surface of the front wall so that the front wall is being between the fixing arm and the stopper wall. Thus, the switch housing is fixed onto the switch holder part.

In a possible embodiment of the present invention, the fixing arm comprises at least one knurled part provided on a side of the fixing arm closer to the first wall surface. Thus, the fixing arm easily holds and is fixed to the front wall.

In a possible embodiment of the present invention, the switch housing comprises at least one back cover provided so as to cover an access opening of the switch housing. Thus, contact of the operator to the electrical cables is prevented during assembly or dismantling of the switch housing.

In a possible embodiment of the present invention, the switch holder part comprises a base wall which is coplanar with the outer side surface, and at least one support wall provided so as to be configured in a perpendicular plane with respect to base wall and the front wall. Thus, the switch holder can be more rigid.

In a possible embodiment of the present invention, the power switch arrangement is provided on a side of the outer side surface closer to a door hinged to the body. Thus, the power switch arrangement can be easily mounted.

In a possible embodiment of the present invention, the first connection housing is provided on the support wall. Thus, the connection between the switch holder part and the fixing part is reinforced without taking a space on the front wall which provides connection to the switch assembly part.

In a possible embodiment of the present invention, the second connection housing is provided on the support wall. Thus, the connection between the switch holder part and the cover part is reinforced without taking a space on the front wall which provides connection to the switch assembly part.

In a possible embodiment of the present invention, the switch holder part comprises a top cover wall extending parallel to the base wall, for covering the power switch at least partly. Thus, the power switch is prevented from being damaged from environmental factors.

In a possible embodiment of the present invention, two second engagement portions are provided on the outer side surface so as to be spaced apart each other. Thus, position of the power switch arrangement is easily changeable.

In a possible embodiment of the present invention, two second engagement portions are provided on the fixing part so as to be spaced apart each other. Thus, position of the power switch arrangement is easily changeable.

The present invention is moreover a power switch assembly method for a cooling device, wherein the method comprises the steps of:
positioning the power switch in a switch housing,
connecting the switch housing to a switch holder part which has at least one first engagement portion,
connecting a fixing part, having at least one second engagement portion, to a body of the cooling device,
sliding the first engagement portion and the second engagement portion and connecting thereof to each other. Thus, the switch holder part wherein the power switch is positioned, is easily fixed.

### BRIEF DESCRIPTION OF THE FIGURES

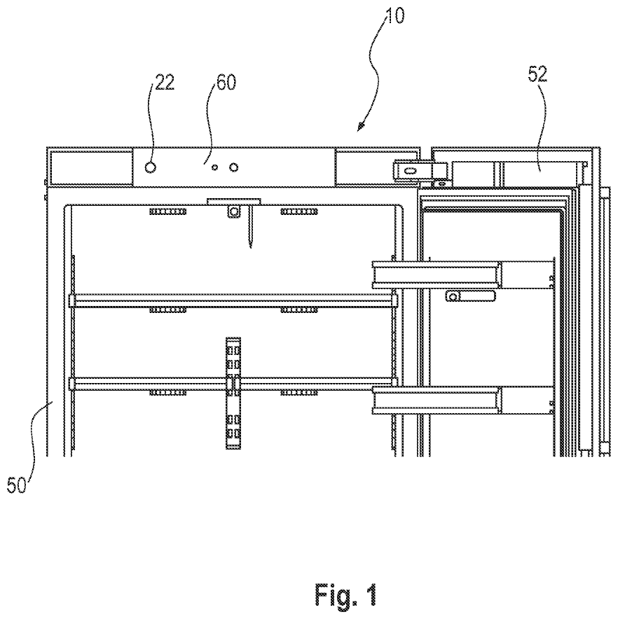

In FIG. 1, a representative frontal view of the cooling device is given.

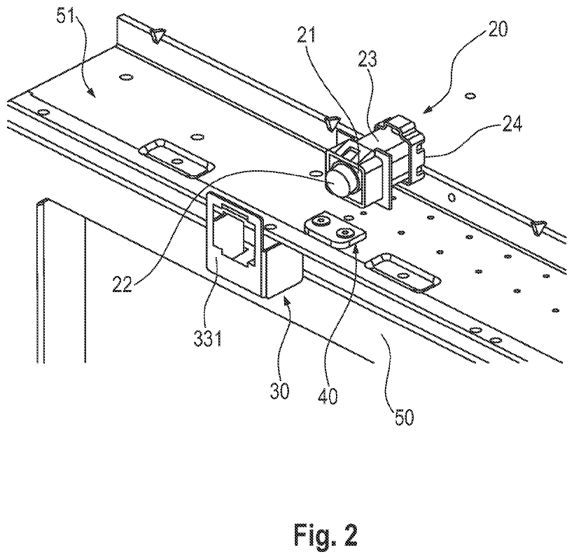

In FIG. 2, a representative perspective view of the switch holder part, the switch housing and the fixing part is given.

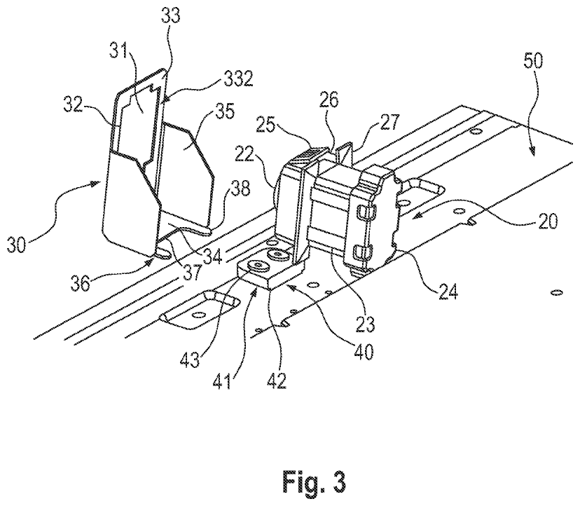

In FIG. 3, a representative zoomed perspective view of the switch holder part, the switch housing and the fixing part is given.

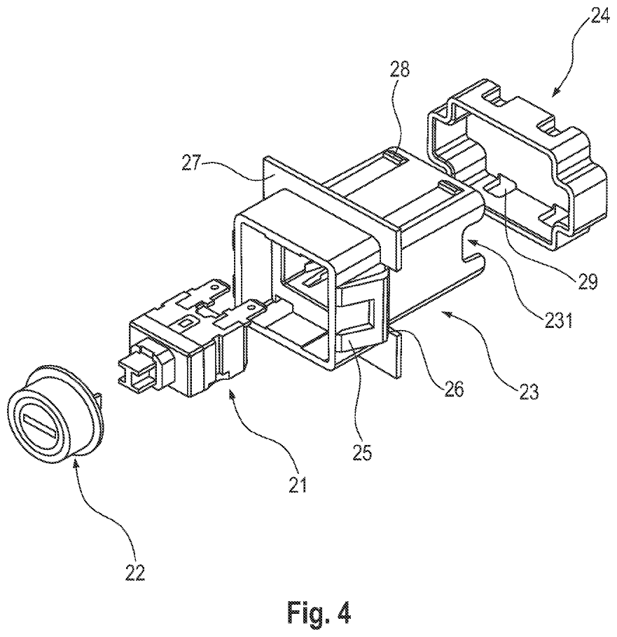

In FIG. 4, a representative exploded perspective view of the switch holder part is given.

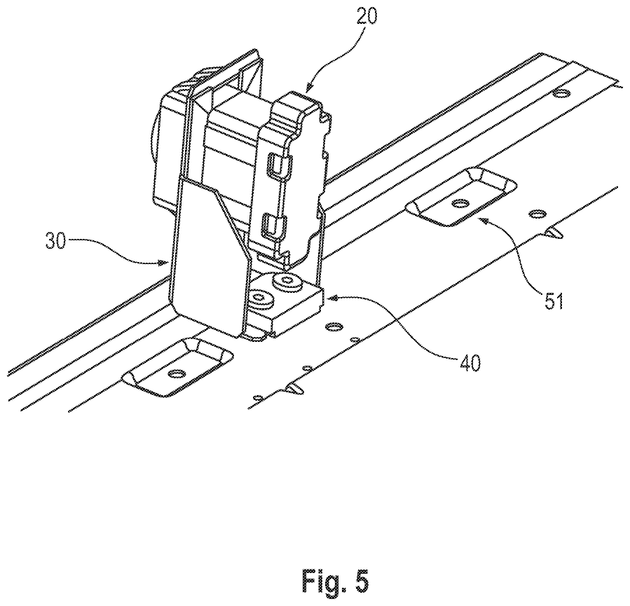

In FIG. 5, a representative assembled perspective view of the switch holder part, the switch housing and the fixing part is given.

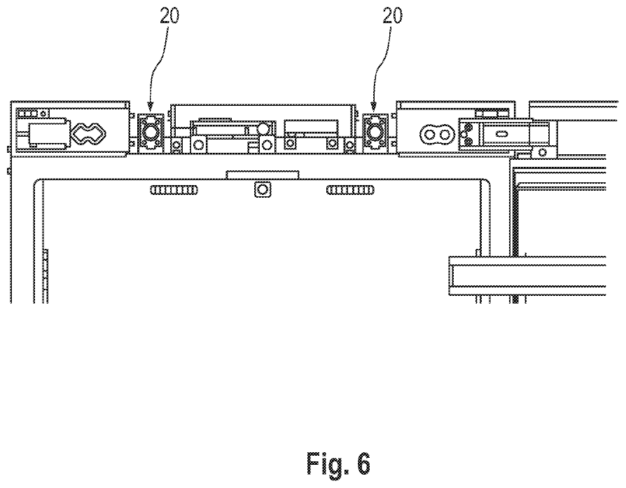

In FIG. 6, a representative frontal view of the positioning of the subject matter switch on the cooling device is given.

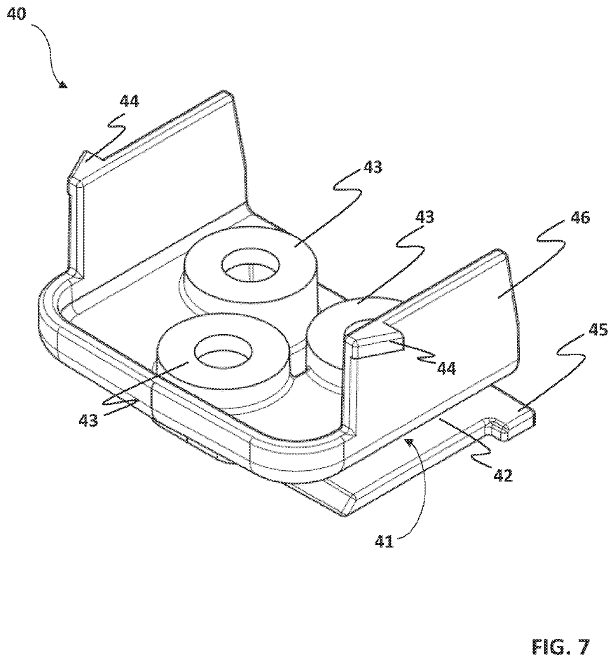

In FIG. 7, a representative perspective view of the fixing part is given.

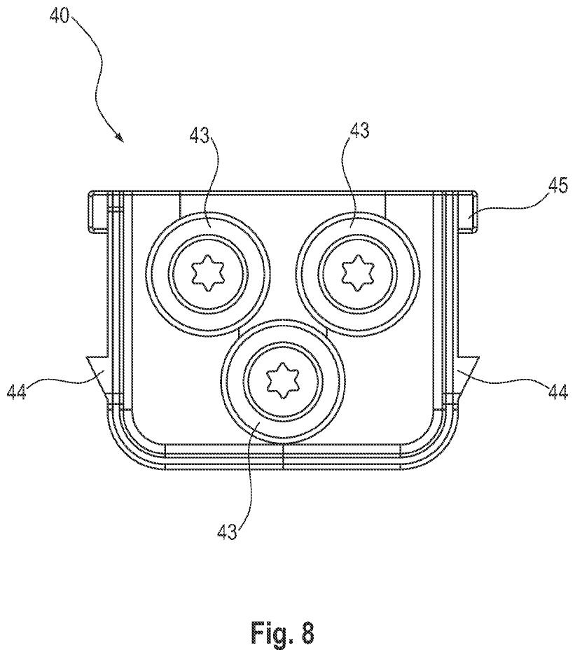

In FIG. 8, a representative top view of the fixing part is given.

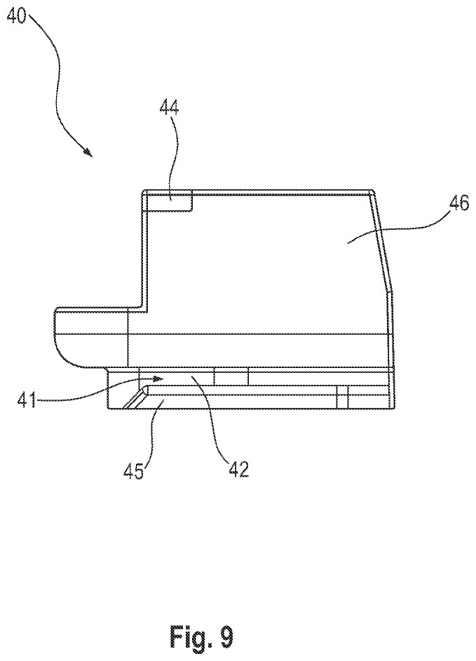

In FIG. 9, a representative side view of the fixing part is given.

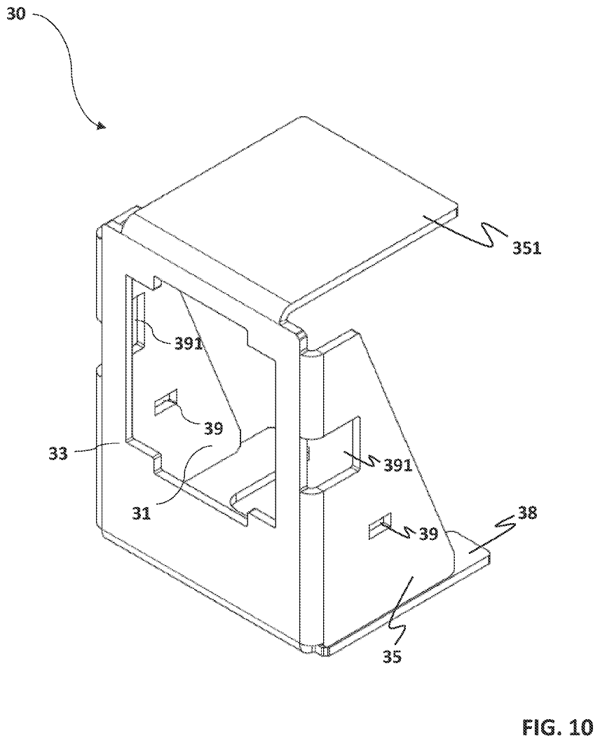

In FIG. 10, a representative perspective view of the switch holder part is given.

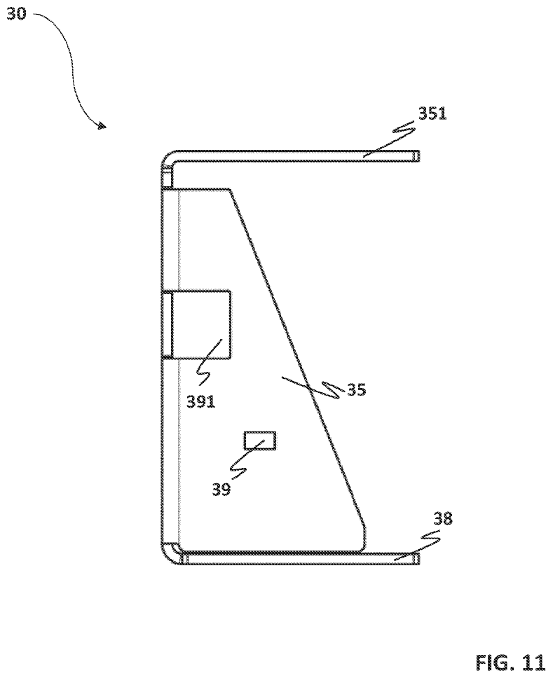

In FIG. 11, a representative side view of the switch holder part is given.

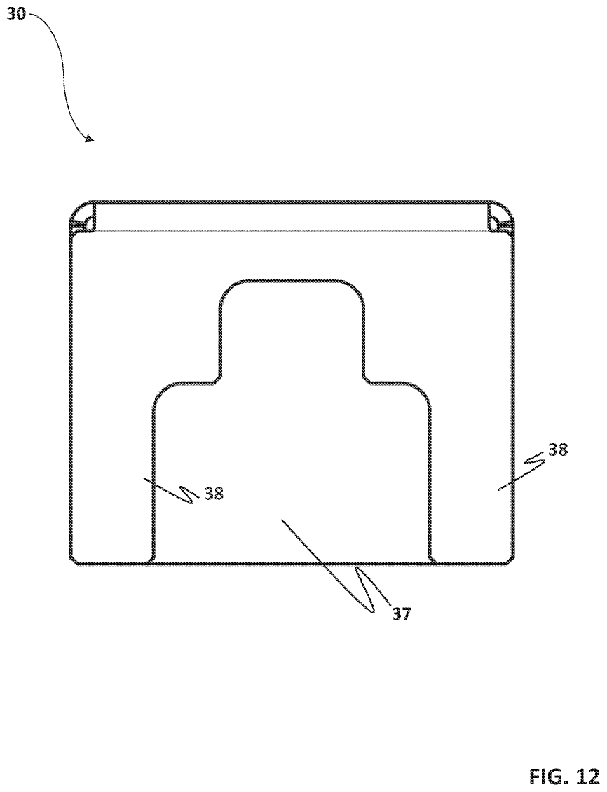

In FIG. 12, a representative bottom view of the switch holder part is given.

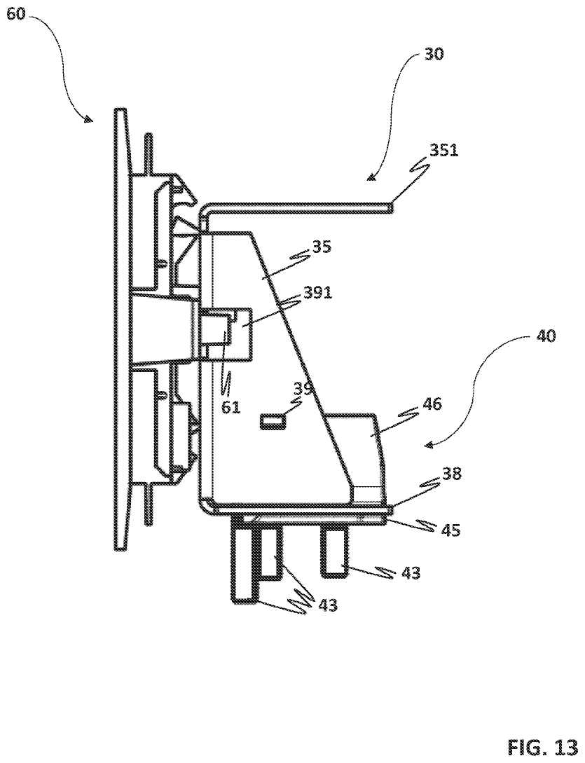

In FIG. 13, a representative side view of the switch holder part, fixing part and the cover part is given.

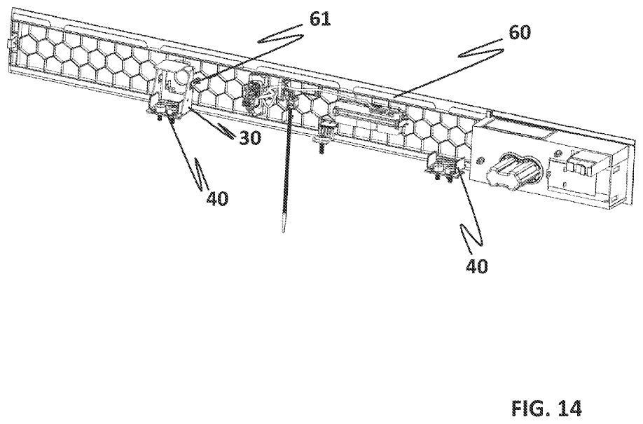

In FIG. 14, a representative perspective view of the switch holder part, fixing part and the cover part is given.

### DETAILED DESCRIPTION OF THE FIGURES

In this detailed description, the subject matter assembly of power buttons on cooling devices are explained with references to examples without forming any restrictive effect only in order to make the subject more understandable.

In FIG. 1, a frontal view of the cooling device (10) is given. Accordingly, at least one power switch (21), which provides power control, is provided at the front face of said cooling device (10) and on the surface which corresponds to at least one door (52). In other words, the cooling device (10) comprises a body (50) and a power switch arrangement. The switch arrangement has a switch housing (23) fixed on an outer side surface (51) facing outside, of the body (50) and the power switch (21) positioned in the switch housing (23). The cover part (60) is provided on the outer side surface (51) to hide the switch arrangement at least partly.

In FIG. 7, a perspective view of the fixing part (40) is given. The second engagement portion (41) is provided on the fixing part (40). The second engagement portion (41) has a planar surface where the first engagement portion (36) is slidably engaged. Two second engagement portions (41) are provided on the fixing part (40) so as to be spaced apart each other. The fixing part (40) comprises a base portion (45) contacting to the outer side surface (51) of the body (50). The fixing part (40) further comprises a mounting portion (46) provided on the base portion (45). The second engagement portion (41) is provided in between the base portion (45) and the mounting portion (46). Referring to FIG. 7 and FIG. 9, the second engagement portion (41) is positioned enough higher than the outer side surface (51) of the body (50) in such a way that even the most extreme surface variation of the outer side surface (51) is below the second engagement portion (41). Therefore, connecting the switch holder part (30) to the fixing part (40) is made easier.

Referring to FIG. 7-9, the fixing part (40) has at least one first connection protrusion (44). The first connection protrusion (44) is provided on the mounting portion (46). The first connection protrusion (44) has a triangular cross section. Referring to FIG. 10-11, the switch holder part (30) has at least one respective first connection housing (39). The first connection protrusion (44) and the first connection housing (39) are sized and shaped to engage each other. The first connection protrusion (44) has an inclined surface to make easier to be engaged with the first connection housing (39) when the switch holder part (30) is moved to the fixing part (40). The first connection protrusion (44) is provided at the upper corner of the mounting portion (46). In the preferred embodiment of the present invention, a first connection protrusion (44) is provided for each upper corner of the mounting portion (46). The number of first connection protrusion (44) is equal to the number of first connection housing (39). The first connection protrusion (44) is made of a flexible material. Therefore, the switch holder part (30) is removed from the fixing part (40) by flexing the first connection protrusion (44) when desired.

In FIG. 13 and FIG. 14, a representative perspective view of the switch holder part (30), fixing part (40) and the cover part (60) is given. The cover part (60) is provided on the outer side surface (51) so as to be configured in a perpendicular plane with respect to the outer side surface (51). The cover part (60) is provided with at least one second connection protrusion (61) extending outside of the body (50). As seen in FIG. 13, the switch holder part (30) comprises a respective second connection housing (391). The second connection protrusion (61) and the second connection housing (391) are sized and shaped to engage each other. Two second connection protrusions (61) are provided on the cover part (60) so as to be spaced apart each other. The second connection housing (391) is formed as a cut-out on the switch holder part (30). The second connection protrusion (61) is made of a flexible material. Therefore, the switch holder part (30) may be removed from the cover part (60) by flexing the second connection protrusion (61) when desired.

In FIG. 8, a top view of the fixing part (40) is given. The fixing part (40) is removably assembled to the body (50) by means of at least three mounting members (43). The mounting members (43) are provided on the mounting portion (46). The mounting members (43) are connected to the outer side surface (51) by passing through the base portion (45). Three mounting members (43) are provided in such a way as to form an imaginary triangle when the center points of the mounting members (43) are joined by imaginary lines. In other words, the mounting members (43) are provided in a misalignment manner. In a preferred embodiment, two mounting members (43) are aligned and the third mounting members is provided in such a way as to form an imaginary triangle when the center points of the mounting members (43) are joined by imaginary lines.

In FIG. 2, a perspective view of a switch assembly part (20), the switch holder part (30) and an external fixing part (40), to be assembled onto the body (50) of the cooling device (10), is given. The body (50) surrounds at least one storage compartment of the cooling device (10). At least one door (52) is hinged to the body (50) for opening and closing of the storage compartment. Accordingly, said power switch (21) is in assembled form into at least one switch housing (23). Said switch assembly part (20) has at least one power switch (21), at least one button (22), at least one switch housing (23) and at least one back cover (24).

The switch assembly part (20) is essentially a body which provides assembly of the power switch (21) to the cooling device (10). The switch assembly part (20) provides realization of the assembly and service processes in an easier manner thanks to the compact structure thereof.

Said switch holder part (30) is a carrier part where the switch assembly part (20) is connected. Said switch holder part (30) provides connection of the switch assembly part (20) to the cooling device (10).

Said fixing part (40) provides fixation of the switch assembly part (20) and the switch holder part (30) to the body (50).

In FIG. 3, a zoomed perspective view of the switch assembly part (20), the switch holder part (30) and the fixing part (40), to be assembled onto the body (50), is given. Said switch housing (23) is essentially being a casing which accommodates the power switch (21) therein and which provides the elements needed for the assembly process thereon. The back cover (24) is assembled to the back of the switch housing (23) and provides insulation for the switch assembly part (20).

The switch holder part (30) has a front wall (33) for providing connection to the switch assembly part (20), and a base wall (34) for providing connection with the body (50). There is at least one support wall (35) which supports said base wall (34) and said front wall (33). The base wall (34) is coplanar with the outer side surface (51), and said support wall (35) provided so as to be configured in a perpendicular plane with respect to base wall (34) and the front wall (33). Also the switch holder part (30) can be hold by the support wall (35) on mounting process. There is at least one receiving opening (31) provided on the front wall (33). There is at least one periphery (32) around said receiving opening (31). The switch housing (23) is at least partially placed into the receiving opening (31). There is at least one stopper wall (27) provided in a manner protruding outwardly on the outer wall of the switch housing (23). When the switch housing (23) is placed to receiving opening (31), the stopper wall (27) is rested to the front wall (33). Moreover, there is at least one fixing arm (25) which extends outwardly from the outer wall of the switch housing (23) and which provides connection to the switch holder part (30). In a possible embodiment of the present invention, two fixing arms (25) are positioned in a mutual manner with respect to each other. In other words, front wall (33) has a first wall surface (331) and a second wall surface (332). When the switch housing (23) is placed to receiving opening (31), the fixing arms (25) is rested on the first wall surface (331) and the stopper wall (27) is rested on the second wall surface (332).

The end parts of the fixing arm (25) have at least one knurled part (26). While the switch housing (23) passes through receiving opening (31), the fixing arms (25) make a bending movement and pass through the receiving opening (31). By means of this bending movement, the fixing arm (25) contacts said periphery (32), and the front wall (33) is compressed between the fixing arms (25) and the stopper wall (27). Thus, the switch assembly part (20) is fixed on the switch holder part (30). Said knurled part (26) facilitates assembly and dismantling processes by means of its stepped structure. At the same time, there is no need for precision in the dimension tolerances of the fixing arm (25).

Referring to FIG. 10 and FIG. 11, the first connection housing (39) is provided on the support wall (35). The first connection housing (39) has a rectangular cross section. The first connection housing (39) is formed as a cut-out on the support wall (35).

Referring to FIG. 10, FIG. 11 and FIG. 13, the second connection housing (391) is provided on the support wall (35). The second connection housing (391) is formed on the support wall (35) so as to be near to the front wall (33). Therefore, connecting the switch holder part (30) to the cover part (60) is made easier.

Referring to FIG. 10, FIG. 11 and FIG. 13, the switch holder part (30) comprises a top cover wall (351) extending parallel to the base wall (34), for covering the power switch (21) at least partly. The top cover wall (351) is provided on the opposite side of the base wall (34). The top cover wall (351) is provided on switch holder part (30) so as to be configured in a perpendicular plane with respect to the front wall (33) and the support wall (35).

The part which realizes the connection of the switch holder part (30) with the fixing part (40) is at least one first engagement portion (36). In a possible embodiment of the present invention, at least one engagement extension (38), which is provided on said first engagement portion (36) and which extends towards the fixing part (40), realizes this connection. In a possible embodiment of the present invention, two engagement extensions (38) are provided in a symmetric manner to each other. As seen in FIG. 12, at least one sleeve (37), provided between the engagement extensions (38), functions as a housing for the connection to the fixing part (40).

The fixing part (40) has at least one second engagement portion (41). The second engagement portion (41) has at least one engagement channel (42) which functions as a guide for the engagement extension (38). In a possible embodiment of the present invention, two engagement channels (42) are provided in a symmetric manner to each other at the two sides of the fixing part (40). The distance between the engagement extensions (38), in other words, the sleeve (37) width is provided in a compliant manner to the distance between the engagement channels (42). Accordingly, the engagement extensions (38) are aligned with the engagement channels (42) and afterwards, the switch holder part (30) is slid and the engagement extensions (38) are placed to the engagement channels (42).

When the engagement extensions (38) are placed to the engagement channels (42), the connection of the switch holder part (30) and the fixing part (40) is provided.

The fixing part (40) is removably assembled to the body (50) by means of at least one mounting member (43) which functions as fixation element. In a possible embodiment of the present invention, two mounting members (43) are provided in a symmetric manner to each other.

In FIG. 4, an exploded perspective view of the switch assembly part (20) is given. Accordingly, the power switch (21) is positioned in the switch housing (23). Said button (22) provides easily controlling of the power switch (21) by the user. The switch housing (23) has an access opening (231) which using cable connection. The back cover (24) closes the access opening (231). The back cover (24) made by plastic material which is dielectric material. Thus, it provides safe and easy access inside of switch housing (23).

At the part where the connection of the switch housing (23) to the back cover (24) will be realized, there is at least one fixing extension (28) which functions for fixation for the assembly. In a possible embodiment of the present invention, four fixing extensions (28) are provided in a symmetric manner to each other. There is at least one guide (29) provided on the back cover (24) and which provides fixation of the fixing extension (28) by means of its groove structure. By means of the connection of the fixing extension (28) to the guide (29), the assembly of the switch housing (23) and the back cover (24) is realized. In a possible embodiment of the present invention, four guides (29) are provided in a symmetric manner to each other.

In a possible embodiment of the present invention, the assembly process is realized as follows:

The power switch (21) is placed into the switch housing (23) and is controlled by a button (22) connected thereto. The rear part of the switch housing (23) is closed by the back cover (24). The switch housing (23) passes through the receiving opening (31) by means of the fixing arm (25) and the fixing arm (25) prevents the part from removing from here. By means of the contact of the front wall (33) and the stopper wall (27), the switch holder part (30) is prevented from sliding on the switch housing (23). Thus, the switch assembly part (20) and the switch holder part (30) are assembled to each other.

In FIG. 5, fixation of these joining parts to the body (50) is provided by means of the fixing part (40). The assembly process is completed by means of connection of the first engagement portion (36), provided on the switch holder part (30), and of the second engagement portion (41), provided on the fixing part (40), to each other.

In FIG. 6, in a possible embodiment of the present invention, there are two switch housings (23) provided on the cooling device (10) such that one of the switch housings (23) is positioned at the right of the cooling device (10) and the other one of the switch housings (23) is positioned at the left of the cooling device. Thus, when the door (52) direction of the cooling device (10) is changed, the switch mechanism can be easily carried. In other words the present invention has two second engagement portions (41) are provided on the outer side surface (51) so as to be spaced apart each other.

By means of these embodiments, the present invention brings together the advantages like easy accessibility to the switch, assembly and maintenance easiness, assembly speed and compliancy to door direction changes.

### REFERENCE NUMBERS

10 Cooling device
20 Switch assembly part
21 Power switch
22 Button
23 Switch housing
231 Access opening
24 Back cover
25 Fixing arm
26 Knurled part
27 Stopper wall
28 Fixing extension
29 Guide
30 Switch holder part
31 Receiving opening
32 Periphery
33 Front wall
331 First wall surface
332 Second wall surface
34 Base wall
35 Support wall
351 Top cover wall
36 First engagement portion
37 Sleeve
38 Engagement extension
39 First connection housing
391 Second connection housing
40 Fixing part
41 Second engagement portion
42 Engagement channel
43 Mounting member
44 First connection protrusion
45 Base portion
46 Mounting portion
50 Body
51 Outer side surface
52 Door
60 Cover part
61 Second connection protrusion

1-15. (canceled)

16. A cooling device, comprising:
a body having an outer side surface facing outward;
an external fixing part connected to said outer side surface, said external fixing part having a second engagement portion; and
a power switch arrangement having a switch holder part including a first engagement portion configured to be slidably engaged with said second engagement portion;
said power switch arrangement having a switch housing fixed on said outer side surface and a power switch positioned in said switch housing, said switch housing configured to be mounted to said switch holder part.

17. The cooling device according to claim 16, wherein said fixing part includes a base portion and a mounting portion provided on said base portion, said second engagement portion being disposed between said base portion and said mounting portion.

18. The cooling device according to claim 16, wherein said fixing part has at least one first connection protrusion, said switch holder part has at least one first connection housing, and said at least one first connection protrusion and said at least one first connection housing are sized and shaped to respectively engage each other.

19. The cooling device according to claim 16, which further comprises:
a cover part disposed on said outer side surface so as to be configured in a perpendicular plane with respect to said outer side surface;
said cover part having at least one second connection protrusion extending outside of said body;
said switch holder part including a second connection housing; and
said second connection protrusion and said second connection housing being respectively sized and shaped to engage each other.

20. The cooling device according to claim 16, wherein said fixing part has at least three mounting members having centers forming an imaginary triangle by joining said centers with imaginary lines, said at least three mounting members configured to removably assemble said fixing part to said body.

21. The cooling device according to claim 16, wherein said second engagement portion has at least one engagement channel, and said first engagement portion has at least one engagement extension configured to be at least partially placed into said at least one engagement channel.

22. The cooling device according to claim 21, wherein said at least one engagement channel includes two engagement channels, and said at least one engagement extension includes two engagement extensions.

23. The cooling device according to claim 22, wherein said switch holder part has a sleeve disposed between said two engagement extensions, and said fixing part is disposed at least partially inside said sleeve upon said two engagement extensions being at least partially placed respectively into said two engagement channels.

24. The cooling device according to claim 16, wherein said switch holder part includes a front wall extending in a direction away from said outer side surface, defining a connection region for mounting said switch housing.

25. The cooling device according to claim 24, wherein said switch holder part includes a base wall being coplanar with said outer side surface, and at least one support wall provided in a perpendicular plane relative to said base wall and said front wall.

26. The cooling device according to claim 25, wherein said fixing part has at least one first connection protrusion, said switch holder part has at least one first connection housing provided on said at least one support wall, and said at least one first connection protrusion and said at least one first connection housing are sized and shaped to respectively engage each other.

27. The cooling device according to claim 25, which further comprises:
a cover part disposed on said outer side surface so as to be configured in a perpendicular plane with respect to said outer side surface;
said cover part having at least one second connection protrusion extending outside of said body;
said switch holder part including a second connection housing provided on said at least one support wall; and
said second connection protrusion and said second connection housing being respectively sized and shaped to engage each other.

28. The cooling device according to claim 25, wherein said switch holder part includes a top cover wall extending parallel to said base wall for at least partly covering said power switch.

29. The cooling device according to claim 16, wherein said second engagement portion is one of two second engagement portions being mutually spaced apart on said fixing part.

30. A power switch assembly method for a cooling device, the method comprising:
positioning the power switch in a switch housing;
connecting the switch housing to a switch holder part having at least one first engagement portion;
connecting an external fixing part, having at least one second engagement portion, to a body of the cooling device; and
sliding the switch holder part towards the fixing part for interconnecting the first and second engagement portions.
